(19) United States
(12) Patent Application Publication
(10) Pub. No.: US 2013/0305228 A1
(43) Pub. Date: Nov. 14, 2013

(54) REDUCING APPLICATION STARTUP TIME THROUGH ALGORITHM VALIDATION AND SELECTION

(71) Applicant: MOCANA CORPORATION, San Francisco, CA (US)

(72) Inventors: Kenneth R. BLACK, Lakeland, FL (US); Caroline L. YAO, Alameda, CA (US)

(73) Assignee: Mocana Corporation, San Francisco, CA (US)

(21) Appl. No.: 13/891,922

(22) Filed: May 10, 2013

Related U.S. Application Data
(60) Provisional application No. 61/645,339, filed on May 10, 2012.

(51) Int. Cl. G06F 11/36

(52) U.S. Cl. CPC G06F 11/3688
USPC 717/131

(57) ABSTRACT

An application developer is able to select from a library only those algorithms or functions that are needed. When the application starts on a device, only those algorithms will perform a self-test thereby significantly reducing application start-up time. This is in lieu of the conventional practice of having all the algorithms in library perform a self-test at application runtime. The application developer, by changing parameters to certain functions in the library, can add and remove algorithms as the application changes. The service provider providing the library can still make a generic offering of the full library to its customers and, through the new functionality, facilitate application developer selection of algorithms that are needed. This reduction of start-up time is particularly beneficial on mobile devices where processing power may be limited.

### CROSS-REFERENCE TO RELATED APPLICATIONS

This application claims priority under U.S.C. §119(e) to pending U.S. Provisional Application No. 61/645,339 filed May 10, 2012, entitled “RUNTIME CRYPTOGRAPHIC ALGORITHM VALIDATION AND SELECTION,” incorporated by reference in its entirety.

### BACKGROUND OF THE INVENTION

1. Field of the Invention

The present invention relates to application software and computing devices. More specifically, it relates to enabling application developers to select algorithms needed for their applications and having only those selected algorithms self test at application runtime.

2. Description of the Related Art

Software applications, especially for mobile devices, have become increasingly widespread and sophisticated. Many of these applications, referred to as apps in specific contexts, execute mostly on smart phones and tablets. It is expected that apps will also run on other Internet-enabled devices, some of which may have less processing power and memory than smartphones and tablets. These include wearable sensors, such as watches and goggles, health monitoring sensors, and the like. Apps will also run increasingly on TVs, motor vehicles, and appliances, and systems, such as climate control and security systems in residences and businesses. The point being that the processing power of some of these systems and devices will likely not be as great as that on a PC or tablet. Increasingly sophisticated apps will run on devices, sensors, and systems that may not have the full computational capability that exists today in mobile devices. At the same time, users' expectations will not decrease with regard to performance and speed. For example, users will still expect start-up time of an app on a mobile device or sensor to be fast; they will expect a similar user experience.

As noted, apps prevalent today on smartphones and tablets are getting more sophisticated and using more functions, such as cryptographic and security-related functions, some of which need to be certified by independent entities. The increasing use of these functions (other examples may include graphics algorithms, healthcare-related functions, medical-related functions, and so on) often effects start-up time of an app or application. Functions or algorithms are in a library and may need to be authenticated or certified, typically when the user starts the app, to ensure the algorithms have not been modified.

For example, if there are n algorithms in a library, then each may have to be tested, certified, or otherwise validated. In one scenario, a service provider may provide a shared library of cryptographic functions which have been authenticated and certified (e.g, FIPS certified). App developers who write apps that need FIPS certified crypto algorithms may use (through a license or purchase) the library of FIPS certified algorithms from the service provider, such as Mocana Corporation of San Francisco, which makes a generic offering of FIPS-certified crypto functions. When the app is started up by an user on a device and calls a function from the library, the function does a self-test to ensure that it has not been modified. Consequently, app start-up time is impacted.

It would be desirable to enable an app developer to specify only those algorithms or functions in the library that are needed for the app and have only those tested instead of all n algorithms. It would be preferable if app initialization time on a device or system was reduced thereby maintaining an acceptable user experience. It would also be desirable if service providers (who provide the libraries and related functions) can continue to make generic offerings of their products instead of having to customize libraries for individual app developers.

### SUMMARY OF THE INVENTION

In one aspect of the present invention, an application developer is able to select from a library only those algorithms or functions that are needed and therefore will perform self-tests when the application starts up on a device or system. This is in lieu of the conventional practice of having all the algorithms in library perform a self-test at application runtime even if only a subset of them are needed. As a result, with the present invention, the start-up time of an application is significantly reduced. In addition, the application developer, by changing parameters to certain functions in the library, can add and remove algorithms as the application changes. The service provider providing the library can still make a generic offering of the full library to its customers and, through the new functionality of the present invention facilitate application developer selection of algorithms that are needed. This reduction of start-up time is particularly beneficial on mobile devices where processing power may be limited, but is also advantageous on servers, PCs, and other systems that run applications and link to a library for specific functionality.

In one embodiment, the library supplied to the application developer has multiple algorithms. In one example, these are FIPS-certified cryptographic algorithms. In other embodiments, the library may contain functions and algorithms for other types of functionality (cryptography is merely one example). When used in an end-user application, the algorithms self-test to ensure that they have not been modified or tampered with. Some of the functions for doing this include a start-up self-test function, a self-test status function, a data structure for storing the algorithms selected by the application developer, an API guard, and others. In one embodiment these functions and data structures are all contained in the library, linked to and called by the application.

Embodiments of the present invention may be described as being implemented in three stages. The first is application coding where the developer has bought or licensed the library from a service provider (e.g., providing expertise and specialized algorithms/functions in an area needed by the developer). The library contains, for example, a full set of certified cryptographic algorithms and functions needed for runtime self-testing. During application coding, the developer determines which algorithms from the library are needed and enables only those algorithms using a data structure supplied in the library. This is the stage where the developer essentially selects which algorithms are going to be used in the application and uses tools in the library to enable those algorithms.

Once the application coding is done, an end user downloads it or installs it on a computing device, such as a server, PC, or mobile device. The end user invokes or starts the application. At application initialization, the application calls the library and executes a function to determine which algorithms in the library were enabled by the application developer (in the first stage). Each of the enabled algorithms performs a self-test at this time. If the algorithms pass the self-test, the process moves onto to stage three which is the normal runtime operation of the application. If one or more of the algorithms fail, they are disabled and an error is returned.

After getting past the application initialization stage, another function in the library is used to ensure that an algorithm passed the self-test before the algorithm is allowed to execute. When an algorithm is invoked, its API guard is called which in turn calls a self-test status function in the library (supplied by the service provider). This functions ensures that everything is ok before, specifically that the algorithm passed the self-test (performed at stage two). If all is ok, it lets the API guard know and the algorithm is allowed to execute.

### BRIEF DESCRIPTION OF THE DRAWINGS

References are made to the accompanying drawings, which form a part of the description and in which are shown, by way of illustration, specific embodiments of the present invention:

FIG. 1 is a block diagram showing components relevant to the implementation of selecting and validating algorithms in a cryptographic library in accordance with one embodiment;

FIG. 2 is a flow diagram showing steps taken by an app during initialization in accordance with one embodiment;

FIG. 3 is a flow diagram showing steps taken by the app during normal runtime operations (after initialization) when an algorithm is invoked in accordance with one embodiment; and

FIGS. 4A and 4B are block diagrams of a computing system suitable for implementing various embodiments of the present invention.

### DETAILED DESCRIPTION OF THE INVENTION

Example embodiments of an application security process and system are described. These examples and embodiments are provided solely to add context and aid in the understanding of the invention. Thus, it will be apparent to one skilled in the art that the present invention may be practiced without some or all of the specific details described herein. In other instances, well-known concepts have not been described in detail in order to avoid unnecessarily obscuring the present invention. Other applications and examples are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

Methods and systems for enabling apps to perform self-testing and self-test verification of specified functions in a library at app runtime are described in the figures. As a result of these methods, apps may start up faster on a computing device, such as a smartphone or a server, and provide a better user experience. The embodiment described herein is in the context of a library of certified cryptographic algorithms which need to be tested before being used each time an app is started. However, the concepts and methods described herein may also be applied to other types of functions and algorithms in a library used by an app, wherein the algorithms need to be inspected in some manner before being used in the app to ensure that they or the library was not modified. In the case of cryptographic algorithms, many are certified by an independent laboratory and need to self-test during runtime of an app to make sure that they have not been tampered with. This is to ensure security and more specifically, their certification. In other embodiments, functions and algorithms, for example, those operating hospital equipment, implementing graphics for a video games, or wager gaming functions for online gaming, and other contexts, may need to self-test to ensure that they operate as expected when called by their host app.

The methods and systems described herein can be used in these and various other contexts. As noted, the context of the described embodiment is certified cryptographic algorithms which is well suited for providing a detailed description of how various embodiments of the present invention may be implemented. It is useful to note that the term “algorithm” is used because of the specific context. The term “function” may also be used in other contexts and such functions (or algorithms) need not be certified; the concepts described herein apply regardless of whether the functions or algorithms are certified.

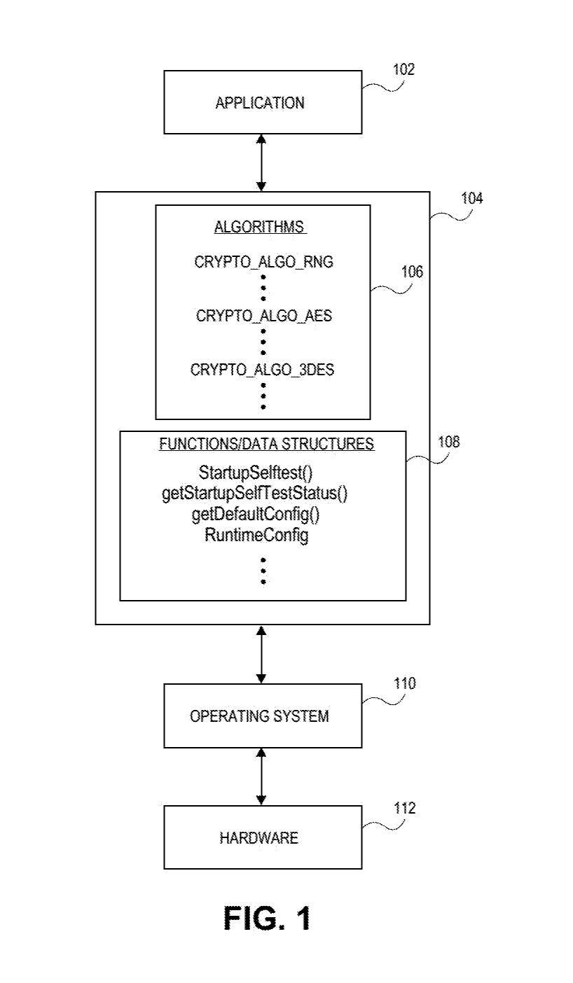

FIG. 1 is a block diagram of components on a computing device relevant to the described embodiment of the present invention. An application 102 executes on a computing device or system and communicates with, that is, links with or makes calls to, cryptographic library 104, typically provided to the application developer by, for example, a security software service provider. In the described embodiment, library 104 contains, in the described embodiment, n number of certified cryptographic algorithms 106. In other embodiments, algorithms 106 may be a list of functions in another area (e.g., online video gaming) needed by application 102. Generally, library 104 provides functionality in a specialized area that the app developer may not be familiar with and would rather rely on a service provider (that is, an expert in that area) so the developer can focus on writing app 102. App 102 may only need a few of the algorithms in box 106. As noted, to ensure that the cryptographic library has not been modified and is operating correctly, it is often required that all the algorithms perform self-tests during app (system) startup. These startup self-tests can take time (e.g., some may take several seconds). Furthermore, it is preferable to have cryptographic algorithms 106 remain in library 104, assuring that any such algorithms used by app 102 have not been modified. The methods and systems of the present invention allow algorithms 106 to remain in library 104 while, at the same time, significantly reducing app start-up time by allowing the app developer to select only those algorithms needed by app 102. Moreover, this is done while allowing the service provider to make a generic offering to developers. That is, offer a non-customized library 104 to all developers and allowing the developers to select which ones are needed.

Library 104 also contains functions and data structures in box 108. In the described embodiment, these include StartupSelfTest( ), getStartupSelfTestStatus( ) and others. Their purpose and roles are described below. There is also a RuntimeConfig data structure and a CRYPTOAlgoNames data structure, both of which are described below. These are functions and data structures that are used to enable selective algorithm self-testing at application runtime. The names of the functions in box 108 are illustrative and relate to one implementation. In other embodiments and contexts, the functions/data structures will have different names.

Library 104 makes calls to operating system 110 which in turn communicates with hardware 112. Application 102 may also communicate directly with operating system 110.

It is helpful at this stage to clarify the entities involved in implementing and using embodiments of the present invention and their respective roles. As noted above, the entities involved are the service provider, the app developer, and the app user. The service provider develops library 104 that includes algorithms 106 and, if needed, attends to certification and testing of the algorithms (e.g., ensures they are FIPS certified, has a certification number, and the like). It also develops and supplies startup self-test functions and data structures 108. It supplies library 104 to an app developer. The developer builds application 102 that needs at least one or more of the algorithms in library 104. The app developer writes app code that links to shared cryptographic library 104. The app user (or end user) executes the app on a computing device, such as a server, PC, or mobile device, at which time the invention is implemented. At runtime only the cryptographic algorithms specified by the app developer perform a self-test (instead of all algorithms 106) and, as a result, the time it takes for app 102 to be up and running on the computing device is shortened.

In one embodiment, cryptographic algorithms 106 in library 104 are listed in a data structure such as the one shown below. Shown are a few examples of cryptographic algorithms.

enum CRYPTOAlgoNames
{

// Random number algos
CRYPTO_ALGO_RNG = 0,
CRYPTO_ALGO_RNG_FIPS186 = 1,
CRYPTO_ALGO_RNG_ECC = 2,
CRYPTO_ALGO_RNG_CTR = 3,
CRYPTO_ALGO_SHA1 = 4,
CRYPTO_ALGO_SHA256 = 5,
CRYPTO_ALGO_SHA512 = 6,
CRYPTO_ALGO_HMAC = 7,
CRYPTO_ALGO_3DES = 8,
// AES related algos
CRYPTO_ALGO_AES = 9,
CRYPTO_ALGO_AES_ECB = 10,
CRYPTO_ALGO_AES_CBC = 11,
CRYPTO_ALGO_AES_CFB = 12,
...

}

The app developer builds app 102 that needs functionality provided by library 104 supplied by a service provider, such as a security software provider, a healthcare software provider, an online gaming partner, and the like. In the described embodiment, the app developer builds an app that has a need for cryptographic functionality. The app code calls a startup self-test function. This function, as well as other functions and data structures, reside in cryptographic library 104. The developer decides which cryptographic algorithms will be needed in the app. The service provider may provide a list of the algorithms by means of a function, named CRYPTO_getDefaultConfig( ) in the described embodiment, in which all the algorithms are enabled by default. The app developer determines that only certain cryptographic functions are needed for the app. During app development, the names of the algorithms are passed as parameters to a startup self-test function. The algorithms may be listed or enabled via a data structure, CRYPTORuntimeConfig, shown here.

```
typedef struct CRYPTORuntimeConfig
{
    enum CRYPTOAlgoNames randomDefaultAlgo;
    /* Must be CRYPTO_ALGO_RNG_FIPS186, ..._RNG_ECC,
or ..._RNG_CTR, */
    intBoolean useInternalEntropy;
    intBoolean
    algoEnabled[NUM_CRYPTO_ALGONAME_VALUES];
} CRYPTORuntimeConfig;
```

As noted, shared library 104 is given to the app developer and contains all the cryptographic algorithms. Those algorithms that are not selected by the developer are still in the shared library but, they are skipped and they do not run self-tests.

A StartupSelftest function, shown below, is called during application initialization. The CRYPTORuntimeConfig data structure is passed as a parameter to the function. As described above, this data structure contains a list of the algorithms that the app developer has selected as being enabled and therefore must run self-testing at runtime.

extern MSTATUS CRYPTO_StartupSelftest(CRYPTORuntimeConfig
*pCRYPTO_config);

This function performs several high-level operations. Its primary function is to ensure that individual algorithms perform their own self-tests and that they are done for all enabled algorithms and performing an integrity check on the library module. It also initializes internal data structures, such as CRYPTORuntimeConfig in the described embodiment. It may also validate user-provided algorithm configuration. For example, this ensures that if a first algorithm requires execution of a second algorithm (i.e., calls the second algorithm), but the app developer has only enabled the first algorithm, then the StartupSelftest function may either return an error code to the first (calling) algorithm or silently enable the second algorithm for the benefit of the calling application. It may also mark all algorithms with a default FAILURE error code. If an algorithm startup self-test is not performed and the algorithm is called by the app, it will fail. The StartupSelftest function may also collate the individual algorithm and integrity check results. If any enabled algorithms have failed, the global status is set to a FAILURE error code.

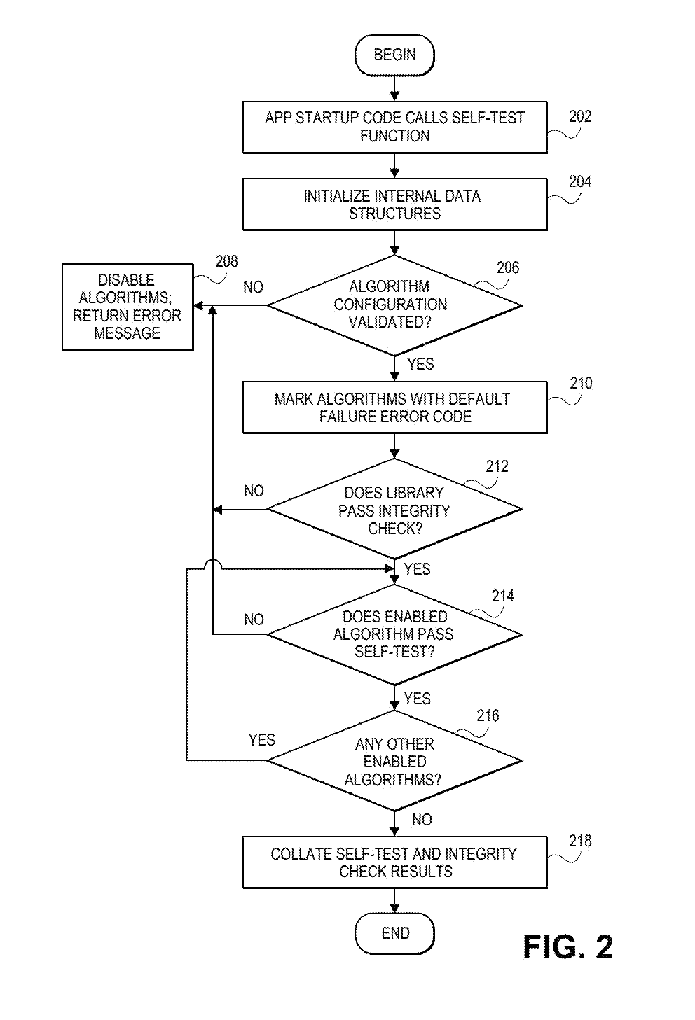

FIG. 2 is a flow diagram of an application initialization process with respect to selective algorithm self-testing in accordance with one embodiment of the present invention. Some of the steps described in FIG. 2 have been explained above but are repeated to further clarify one embodiment of the app initialization process. Prior to the first step, an app user has downloaded or installed an application on a computing device, such as a server, a PC, or a mobile device. The end user starts the application.

At step 202 application code (written by the app developer) calls a start-up self-test function in library 104 (written and supplied by a service provider). In the described embodiment, this is the CRYPTO_StartupSelfTest( ) function. At step 204 the start-up self-test function initializes internal data structures, such as the data structure that indicates which algorithms are enabled by the app developer. At step 206 the start-up function validates the algorithm configuration. If the configuration is not valid, control goes to step 208 where all the algorithms or a subset of those enabled are disabled. An error message may be returned to the end user. An algorithm configuration is not valid, for example, if an enabled algorithm calls or is dependent on one or more algorithms that have been left disabled by the app developer. If the configuration has been validated, control goes to step 210.

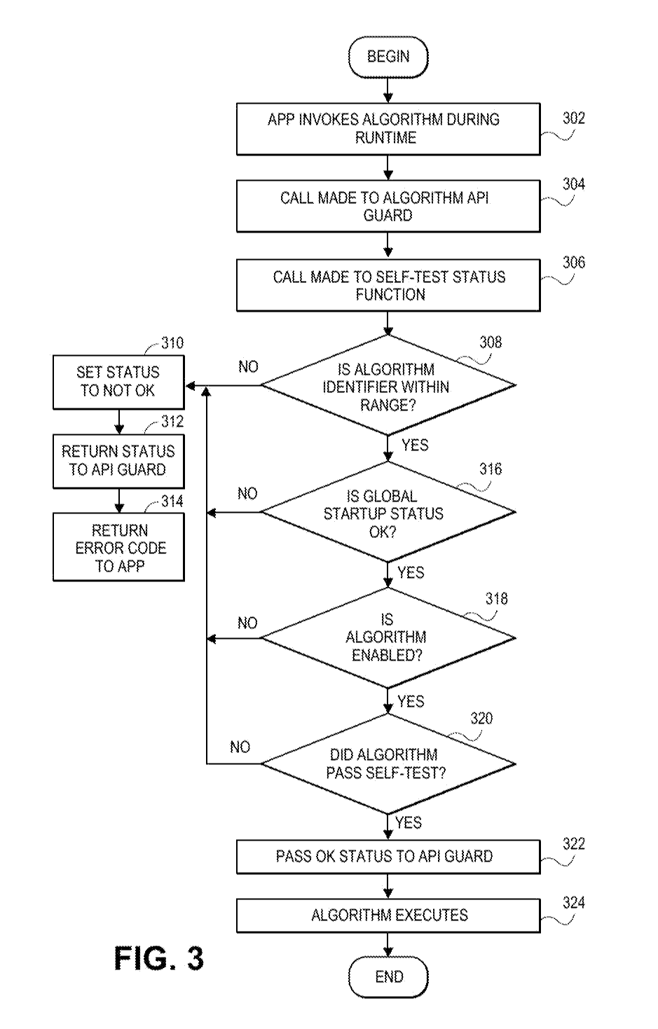

At step 210 the start-up function marks all or some of the algorithms with a default failure or error code. At step 212 it checks to make sure that library 104 passes an integrity check to ensure that the cryptographic library has not been tampered with. If it fails, control goes to step 208. If it passes, control goes to step 214. Here the first enabled algorithm performs a self-test using any suitable testing means in light of the type of algorithm or function, the context, the functionality of library 104 (e.g., some contexts require more rigorous testing than others). In the described embodiment, the self-test may involve FIPS specified functional tests, such as Known Answer Test, where the algorithm is invoked with a known value, and the results of the algorithm are compared with the expected results. At step 214 the start-up self-test function determines whether the algorithm passes the self-test. If it does not, control goes to step 208. If it does, it goes on to the next enabled algorithm at step 216 and repeats step 214. If there are no more enabled algorithms that need to perform self-tests, control goes to step 218 where the self-tests and integrity checks are collated or organized in a suitable manner for use in the next phase described in FIG. 3.

As noted, the StartupSelfTest( ) function is passed a data structure or other parameter specifying which algorithms should self-test at runtime, that is, which algorithms are enabled. This can be done by the app developer setting Booleans for each of the algorithms to either 0 or 1.

In the described embodiment, only algorithms that have been compiled into the library may be enabled by the app developer. In an alternative embodiment, the app developer may use a CRYPTO_getDefaultConfig( ) function instead of “manually” entering the names or identifiers of algorithms to be enabled by listing (i.e., coding) them in an array of Booleans in the “algoEnabled” field of the RuntimeConfig data structure shown above. The function makes it easier for the developer to disable algorithms that are not needed. It provides a default configuration where all algorithms 106 in library 104 are enabled. The developer may then disable those that are not needed. Those that are disabled are turned off and will not run the power-up self tests. The app developer may modify the individual fields returned by getDefaultConfig( ) function and pass the resulting configuration to StartupSelfTest( ) function. As described in FIG. 2, the startup self-test is called as part of the app initialization which occurs when the end user invokes the app.

At startup time the library examines the configuration data structure that lists the cryptographic algorithms that the developer wants to have enabled. The library CRYPTO_startupSelfTest code runs startup self-tests on those cryptographic algorithms. As described below, if the app attempts to use one of the other algorithms that was not enabled (e.g., a 3DES or AES algorithm) the app will fail or provide an error message. As noted above, those that are selected by the app developer are set to true (or 1) in the data structure CRYPTORuntimeConfig, specifically in the “algoEnabled” field. These are passed to CRYPTO_StartupSelftest or an equivalent function which is run at app startup time.

After the selected algorithms perform self tests, the app executes in a normal or conventional manner. It starts calling functions and utilizes an API guard that manages execution of the cryptographic algorithms in the app by looking at the start-up self-test results.

If the status is not ok, the API guard returns an error to the code in the app calling the function and no cryptographic operation will be performed. In one embodiment, each of the cryptographic functions provided within the library has an API guard. In the code below, the app calls a cryptographic function (e.g. MY_encryptFunct in the example code below) in the library. All the operations that occur after the app is started by the app user are transparent to that user. An example of an API guard is provided below.

```
MSTATUS MY_encryptFunct(ubyte* iii, ubyte* outData)
{
  MSTATUS status;
  if (OK != (status = getStartupSelfTestStatus(CRYPTO_ALGO_AES)))
    return status;
  ... <<< encryptFunct functional code >>
}
```

In the described embodiment, a function in the library checks an internal data structure to verify that an algorithm being called by the app has been enabled in the library and that the required startup tests have successfully completed for that algorithm. As noted, the function, that implements the functionality needed by the API guard used within all of the cryptographic functions within the library, may be referred to as getStartupSelfTestStatus( ). This function is called by the algorithm API guard. In addition to checking whether a self-test for the particular algorithm was done and examining its results, there may be other tests, such as overall module integrity tests that the algorithm must pass. There may also be related algorithms which need to pass for the particular algorithm to execute successfully. For example, it is safer to disable all cryptographic functions in the library if the random number function has not been enabled or failed to pass.

Sample pseudo-code for the function is provided below. It shows that only after the called algorithm has passed certain tests, will the function return an OK status to the API guard which will allow the algorithm to execute.

MSTATUS getStartupSelfTestStatus(int CRYPTO_algoid)
{

// Validate the algoid parameter is within range
// First check the global startup status (including integrity check)
// If (globalStartupStatus != OK)
// return globalStartupStatus;
// Verify the individual algorithm is enabled:
// If (individualAlgoEnabled[algoid] != TRUE)
// return STARTUPTEST_INCOMPLETE_FAILURE;
// Check the individual algorithm.
// If (individualAlgoStatus[algoid] != OK)
// return individualAlgoStatus[algoid];
// Check related algorithms and/or children algorithms:
// For example CRYPTO_ALGO_AES should check the children
// aglorithms: CRYPTO_ALGO_AES_xxx ..
CRYPTO_ALGO_AES_yyy
// Use a code structure such as a switch/case statement
// and a loop mechanism to loop through related algorithms
// verifying that each has a successful startup status.
// If all of the above tests pass
// return OK;

}

FIG. 3 is a flow diagram showing app runtime operations with respect to self-testing algorithms in accordance with one embodiment. The app has completed its start-up phase (described in FIG. 2) and is now ready for normal runtime operations. At step 302 the app invokes one of the algorithms in box 106. At step 304 that particular algorithm makes a call to the algorithm API guard. At step 306, the API guard makes a call to getStartupSelfTestStatus( ). As explained in the pseudo-code above, this function performs various tests before responding back to the API guard.

At step 308 the function checks to see if the algorithm identifier is within range or valid. If it is not, control goes to step 310 where the status is set to not OK. From there, the status is returned to the API guard at step 312. At step 314 an error code is returned to the app by the API guard. If the identifier is within range, control goes to step 316 where the function checks to ensure that the global start-up status is ok. The global start-up status may have been previously set in FIG. 2 during app initialization, specifically at step 218, if there was a failure at that time, or it may have been set if an subsequent integrity check failure has occurred in the intervening time. By checking this global flag, if any validation error has occurred on any algorithm, then all algorithms within the library will be disabled; this is the safest implementation. An alternative embodiment may allow some algorithms within the library to continue to operate even while others have failed. If the global status is not OK, control goes to steps 310-314. If it is OK, control goes to step 318. Here the function checks to make sure that the app developer enabled the particular algorithm. If it did not, control goes to step 310-314. If the algorithm was enabled, control goes to step 320. Here the getStartupSelfTestStatus( ) function performs the final test: it determines whether the algorithm passed the self-test. It may get this pass/fail information from the collated self-test and integrity check results created in FIG. 2 during app initialization, specifically at step 218. If the algorithm passed the self-test, the function passes an OK status message to the API guard at step 322. The API guard then lets the algorithm execute at step 324. The application then proceeds with normal runtime operations. The same process is repeated each time an algorithm from box 106 is invoked. This process is repeated for algorithms that have already been checked once.

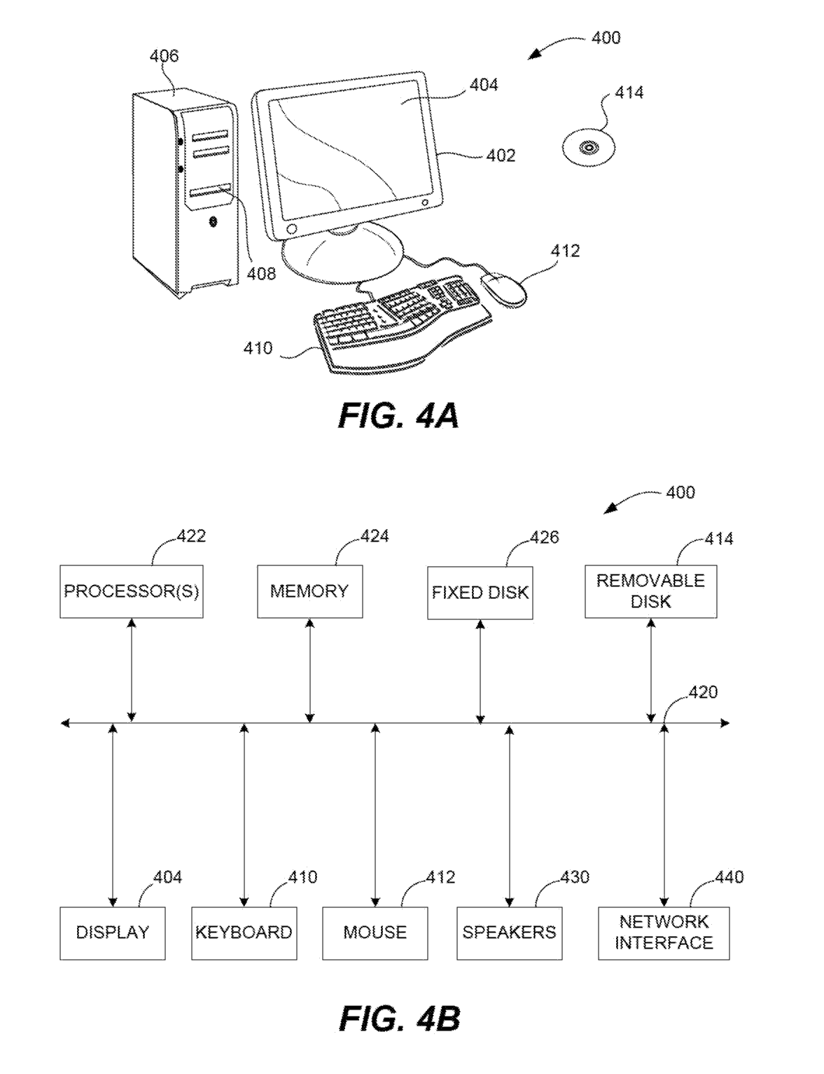

FIGS. 4A and 4B illustrate a computing system 400 suitable for implementing embodiments of the present invention. FIG. 4A shows one possible physical form of the computing system. Of course, the computing system may have many physical forms including an integrated circuit, a printed circuit board, a small handheld device (such as a mobile telephone, handset or PDA), a personal computer or a super computer. Computing system 400 includes a monitor 402, a display 404, a housing 406, a disk drive 408, a keyboard 410 and a mouse 412. Disk 414 is a computer-readable medium used to transfer data to and from computer system 400.

FIG. 4B is an example of a block diagram for computing system 400. Attached to system bus 420 are a wide variety of subsystems. Processor(s) 422 (also referred to as central processing units, or CPUs) are coupled to storage devices including memory 424. Memory 424 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 426 is also coupled bi-directionally to CPU 422; it provides additional data storage capacity and may also include any of the computer-readable media described below. Fixed disk 426 may be used to store programs, data and the like and is typically a secondary storage medium (such as a hard disk) that is slower than primary storage. It will be appreciated that the information retained within fixed disk 426, may, in appropriate cases, be incorporated in standard fashion as virtual memory in memory 424. Removable disk 414 may take the form of any of the computer-readable media described below.

CPU 422 is also coupled to a variety of input/output devices such as display 404, keyboard 410, mouse 412 and speakers 430. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 422 optionally may be coupled to another computer or telecommunications network using network interface 440. With such a network interface, it is contemplated that the CPU might receive information from the network, or might output information to the network in the course of performing the above-described method steps. Furthermore, method embodiments of the present invention may execute solely upon CPU 422 or may execute over a network such as the Internet in conjunction with a remote CPU that shares a portion of the processing.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

We claim:

1. A method of executing an application on a device, comprising:
upon application start-up on the device, identifying one or more algorithms marked as enabled by an application developer, wherein the one or more algorithms are stored in a library called by the application;
causing the one or more algorithms marked as enabled to each perform a self-test utilizing a start-up self-test function stored in the library during application start-up;
upon invocation of an algorithm during normal runtime operation of the application, determining whether the algorithm had previously passed self-testing during application start-up by utilizing a self-test status function; and
enabling execution of the algorithm if determined that algorithm passed self-testing.

2. A method as recited in claim 1 further comprising:
initializing internal data structures in the library, said initializing performed by the start-up self-test function.

3. A method as recited in claim 1 further comprising:
validating an algorithm configuration with respect to the algorithm being invoked.

4. A method as recited in claim 1 further comprising:
marking algorithms in the library with a default error code.

5. A method as recited in claim 1 further comprising:
performing an integrity check on the library.

6. A method as recited in claim 1 further comprising:
collating self-test and integrity check results.

7. A method as recited in claim 1 further comprising:
making a call to an API guard for the algorithm being invoked.

8. A method as recited in claim 7 further comprising:
passing an OK status from the self-test status function to the API guard if the algorithm passed self-testing.

9. A computing device for executing an application comprising:
a processor;
a network interface;
a memory component storing:
an application;
a library containing a plurality of algorithms, a plurality of self-test related functions, and a plurality of self-test related data structures; and
an operating system.

10. A computing device as recited in claim 9 wherein the plurality of self-test related functions include a start-up self-test function and a self-test status function.

11. A computing device as recited in claim 9 wherein the plurality of data structures include a runtime configuration data structure for indicating which algorithms are enabled by an application developer.

12. A computing device as recited in claim 9 wherein the plurality of algorithms include multiple FIPS-certified cryptographic algorithms.
